(19) United States
(12) Patent Application Publication
(10) Pub. No.: US 2001/0020751 A1
(43) Pub. Date: Sep. 13, 2001

(54) Apparatus for aerating water

(75) Inventor: Arnold Jager, Burgdorf (DE)

Correspondence Address: ROBERT W. BECKER & ASSOCIATES, Suite B, 11896 N. Highway 14, Tijeras, NM, 87059, US

(73) Assignee: Gummi-Jager KG GmbH & Cie., Hannover (DE)

(21) Appl. No.: 09/804,628

(22) Filed: Mar. 9, 2001

(30) Foreign Application Priority Data
Mar. 10, 2000 (DE) 100 11 326.5

(51) Int. Cl. B01F 3/04

(52) U.S. Cl. 261/122.1; 261/122.2

(57) ABSTRACT

An elongated apparatus is provided for aerating water, and includes a tubular support body and a sleeve of elastomeric material that surrounds the support body and is provided with slits that open to allow fine bubbles to pass into the water. To achieve a uniform supply of the sleeve with little loss for long apparatus, the inner side of the sleeve is provided with one or more groove-like channels that extend lengthwise relative to the sleeve.

### BACKGROUND OF THE INVENTION

The present invention relates to an elongated apparatus for aerating water with fine bubbles. The apparatus has a rigid, preferably tubular, support body, and a tube-like sleeve of elastomeric material that surrounds the support body and has portions that are provided with slits. The compressed air that is to be passed into the water via the slits is introduced to the apparatus between the support body and the sleeve.

Such apparatus are generally connected via brackets to larger diameter supply conduits, and for this purpose extend transverse thereto. It is desirable to have the apparatus as long as possible, although this creates the problem of being able to introduce the air that is to be supplied at one end of the apparatus in such a way that the fine slits that are present in the sleeve are supplied with air as uniformly as possible over the entire length of the apparatus.

The present invention proceeds from the recognition that the tube-like sleeve is generally produced as an injection molded part, thereby allowing modifications of its cross-sectional shape.

Proceeding from this recognition, it is an object of the present invention to approach the objective of obtaining as uniform as possible, with little loss, of a supply of compressed air for relatively long apparatus.

### BRIEF DESCRIPTION OF THE DRAWING

This object, and other objects and advantages of the present invention, will appear more clearly from the following specification in conjunction with the accompanying schematic drawing, in which:

FIG. 1 is a partially cross-sectioned and partial side view of one exemplary embodiment of the inventive apparatus for aerating water with fine bubbles;

FIG. 2 is an end view of the apparatus of FIG. 1 taken in the direction of the arrow “a” thereof;

FIG. 3 is a partial side view of the apparatus of FIG. 2 taken in the direction of the arrow “b”; and

FIGS. 4 & 5 are an end view and partial end view respectively of modified embodiments of the inventive apparatus, and in particular are views that correspond to the view taken in the direction of the arrow “a” of FIG. 1.

### SUMMARY OF THE INVENTION

To realize the objective of the present invention, the inventive apparatus is characterized primarily in that the sleeve, beyond the cross-sectional portion thereof that is provided with slits, is provided on its inner side with one or more groove-like channels that extend lengthwise relative to the sleeve. In this connection, the wall of the sleeve is expediently thicker in the region of the channel or channels, in order in this manner to reinforce the sleeve and to counteract undesirable deformations of the sleeve due to water pressure that acts on the sleeve from the outside; at the same time, the thickening of this portion of the sleeve is intended to stabilize the shape of the sleeve.

The inventive groove-like channels, which for strength and stability reasons are preferably embodied as rounded channels, provide little resistence for the air that is to be supplied, and easily transport the air over greater distances, whereby the air can then escape laterally toward both sides of the channels, i.e. transverse to the longitudinal extension thereof, and into the slitted portions of the sleeve.

The inventive channels are preferably provided in that region of the sleeve that during use of the apparatus is disposed at the bottom, although it is also possible to dispose the channels to the side, and in such a case preferably on both sides.

Further specific features of the present invention will be described in detail subsequently.

### DESCRIPTION OF PREFERRED EMBODIMENTS

Referring now to the drawing in detail, shown is a support tube 1 that is generally comprised of a rigid, stiff polymeric material; the support tube 1 is surrounded, with play, by a sleeve 2 that is made of rubber or a rubber-like polymeric material. This elongated, linearly extending apparatus is generally a component of an aerating system, which is also provided with an air supply tube to which the inventive apparatus is connected and to which the apparatus extends transversely. The connecting device simultaneously serves for the supply of air for the inventive apparatus, whereby the compressed air is guided in the direction of the arrows “x” between the sleeve 2 and the non-perforated, outwardly smooth support tube 1, so that the fine bubbles can escape upwardly.

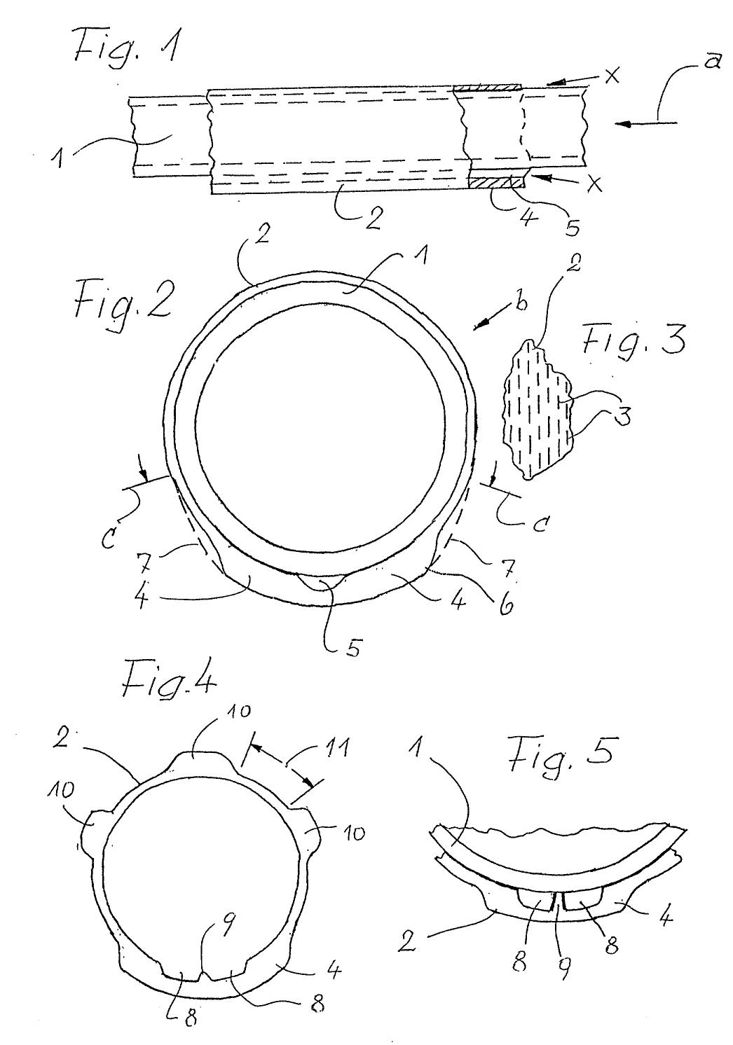

In order for the sleeve 2 to give off fine bubbles, a portion of its periphery is provided with fine slits 3 that pass all the way through, as shown in FIG. 3. The slits 3 open under the effect of the internal air pressure, and close in a water tight manner when the pressure drops or the apparatus is no longer pressurized. In the apparatus illustrated in FIGS. 1 to 3, the largest peripheral region of the sleeve 2 is perforated over the zenith portion that is laterally delimited as shown by the reference symbols “c”.

Approximately one-fourth of the periphery of the sleeve 2 is thickened, and in particular in that region that during use of the apparatus is disposed at the bottom. This thickened region is indicated by the reference numeral 4, and has a thickness that is approximately two to four times greater than the thickness of the remaining peripheral portion of the sleeve 2. The important thing is that the inner side of the sleeve 2, in the central part of the region 4, is provided with a rounded longitudinal groove 5, the depth of which corresponds approximately to one to two times the thickness of the sleeve 2. This groove or channel 5, which extends all the way through over the entire length of the sleeve 2, serves as a special air channel that is delimited radially inwardly by the rigid support body 1; the channel leads the compressed air in an unobstructed manner over the entire length of the apparatus. From this longitudinal groove 5, the air passes to the side into the perforated portion of the sleeve 2 and finally passes via the slits 3 into the water as fine bubbles.

As can be seen from the embodiment illustrated in FIG. 2, the region 4 can merge via a shoulder 6 into the sleeve body proper; however, as indicated by the dashed lines 7, a gradual transition can also be provided.

In the embodiment illustrated in FIGS. 4 and 5, the longitudinal groove 5 can be widened accompanied by the formation of a double channel having two individual channels 8 that are separated from one another by a rib-like support 9.

As can be seen from FIG. 4, the upper portion of the sleeve 1 is reinforced by three spaced-apart, bead-like thickened portions 10, whereby a symmetrical arrangement is provided that affords not only reinforcement but also stabilization to the sleeve 2. Disposed between these thickened portions 10 are regions 11 that are provided with slits as described in conjunction with FIG. 3.

The specification incorporates by reference the disclosure of German priority document DE 100 11 326.5 of Mar. 10, 2000.

The present invention is, of course, in no way restricted to the specific disclosure of the specification and drawings, but also encompasses any modifications within the scope of the appended claims.

What I claim is:

1. An apparatus for aerating water with fine bubbles, comprising:
a rigid support body, and
a sleeve of elastomeric material that surrounds said support body, wherein a portion of said sleeve is provided with slits via which compressed air, which is introduced to said apparatus between said support body and said sleeve, can be passed into water, and wherein on an inner side, beyond said slitted portion, said sleeve is provided with at least one groove-like channel that extends lengthwise relative to said sleeve.

2. An apparatus according to claim 1, which is elongated and wherein said support body is tubular.

3. An apparatus according to claim 1, wherein that portion of said sleeve that is provided with said at least one channel is thicker than is a remaining portion of said sleeve.

4. An apparatus according to claim 1, wherein said at least one channel has a rounded cross-sectional configuration.

5. An apparatus according to claim 1, wherein at least two groove-like channels are provided, and wherein said channels are separated from one another by respective support elements.

6. An apparatus according to claim 1, wherein said at least one channel is disposed in a cross-sectional portion of said apparatus that during use of said apparatus is disposed at the bottom.

7. An apparatus according to claim 1, wherein said sleeve is provided with at least one bead-like thickened portion.

8. An apparatus according to claim 7, wherein said at least one thickened portion is disposed in an upper cross-sectional portion of said sleeve.

9. An apparatus according to claim 7, wherein said sleeve is provided with slitted portions adjacent to or between said at least one thickened portion.

10. An apparatus according to claim 1, wherein said at least one channel has a depth that corresponds approximately to one to two times a thickness of said sleeve in said slitted portion thereof.

11. An apparatus according to claim 3, wherein said thickened portion of said sleeve has a thickness that is approximately two to four times greater than a thickness of said slitted portion of said sleeve.
